(19) United States
(12) Patent Application Publication
(10) Pub. No.: US 2026/0038722 A1
(43) Pub. Date: Feb. 5, 2026

(54) ACTUATOR

(71) Applicant: National Central University, Taoyuan City (TW)

(72) Inventor: Po-Lei LEE, Taoyuan City (TW)

(21) Appl. No.: 18/933,500

(22) Filed: Oct. 31, 2024

(30) Foreign Application Priority Data
Jul. 31, 2024 (TW) 113128434

(51) Int. Cl. H01F 7/08; F04B 45/04; H01F 7/14

(52) U.S. Cl. CPC H01F 7/081; F04B 45/04; H01F 7/14

(57) ABSTRACT

An actuator is provided. The actuator includes a chamber, a coil film and a first magnet. The chamber has an inlet and an outlet. The coil film is disposed in the chamber and includes a plurality of flat coils and a plurality of stacked substrates. The flat coils are interconnected and respectively formed on the substrates. The first magnet is disposed on a common central axis of the plurality of flat coils and is located between the coil film and a first side frame of the chamber.

### CROSS REFERENCE TO RELATED APPLICATION

This application claims the priority of Taiwan Patent Application No. 113128434, filed on Jul. 31, 2024, entitled “ACTUATOR”, and the disclosure of which is incorporated herein by reference.

### FIELD OF INVENTION

The present disclosure relates to an actuator, and more particularly, to an actuator utilizing flat coils.

### BACKGROUND OF INVENTION

Current actuators can be categorized based on their operational principles into piezoelectric type and magnetic thin-film type. Piezoelectric actuators utilize the deformation characteristics of piezoelectric materials (such as piezoelectric crystals) to push films to generate vibrational forces. The core of this technology is that piezoelectric materials undergo mechanical deformation when subjected to an electric field. Related technologies involve applying electrical power to piezoelectric crystals, causing them to compress the attached film, which leads to the expansion or contraction of the film's chamber, thereby generating vibrational forces. Piezoelectric actuators have many applications, such as precision positioning, micro-electro-mechanical systems (MEMS), and medical devices. Relevant patents include Taiwan laid-open No. TW200611872A, entitled “PDMS gate-less micro pump structure and method for producing the same,” and China laid-open No. CN101542122A, entitled “Piezoelectric micro-blower.” However, piezoelectric crystals are expensive and require high voltage to drive. Additionally, the size of the piezoelectric crystal is proportional to the vibrational amplitude, meaning that an actuator with high vibrational amplitude needs more material, which in turn increases costs. These limitations make piezoelectric actuators uneconomical for some applications.

Magnetic thin-film actuators use the interaction between coils and magnetic thin films to achieve chamber expansion or contraction, thus generating vibrational forces. When current flows through a coil, a magnetic field is produced, which interacts with a magnetic thin film, generating mechanical motion. The advantage of this technology is that it can operate at lower voltages and control the magnitudes of the vibrational forces by varying the current. Relevant patents include Taiwan laid-open No. TW201016589A, entitled “Electromagnetic Micro-Pump.” Magnetic thin-film actuators are widely used in audio systems, vibration prompt devices, and some industrial automation equipment. However, magnetic thin-film actuators have certain drawbacks. First, magnetic thin films typically have lower magnetic properties, which makes it difficult to generate high vibrational forces, limiting their effectiveness in applications requiring strong vibrational forces. Additionally, even though performance can be improved by optimizing coil design and enhancing manufacturing process precision, these improvements often increase cost and complexity.

### SUMMARY OF INVENTION

In view of the above-mentioned problems of the prior art, the present disclosure addresses the shortcomings of the conventional technologies and introduces a simple and cost-effective actuator.

The present disclosure provides an actuator, comprising: a chamber, having an inlet and an outlet; a coil film, disposed in the chamber and including a plurality of flat coils and a plurality of stacked substrates, wherein the plurality of flat coils are interconnected and respectively formed on the substrates; and a first magnet, disposed on a common central axis of the plurality of flat coils and located between the coil film and a first side frame of the chamber.

In one embodiment of the present disclosure, the film is a flexible circuit board.

In one embodiment of the present disclosure, the inlet and the outlet are provided on the other side opposite to the first side frame.

In one embodiment of the present disclosure, the inlet is provided with an inlet gate and the outlet is provided with an outlet gate.

In one embodiment of the present disclosure, the inlet gate and the outlet gate operate with inverse actions.

In one embodiment of the present disclosure, further comprising a second magnet, the second magnet is disposed on a common central axis of the plurality of flat coils and is located between the coil film and a second side frame of the chamber.

The present disclosure provides an actuator, comprising: an L-shaped chamber, having an inlet and an outlet; a coil film, disposed in the L-shaped chamber and including a plurality of flat coils and a plurality of stacked substrates, wherein the plurality of flat coils are interconnected and respectively formed on the substrates; and a magnet, disposed on a common central axis of the plurality of flat coils and located between the coil film and one side wall of the L-shaped chamber; wherein a force produced by the interaction between the coil film and the magnet is directed toward the outlet.

In one embodiment of the present disclosure, the film is a flexible circuit board.

In one embodiment of the present disclosure, the inlet is located at the head end of the L-shaped chamber and the outlet is located at the tail end of the L-shaped chamber.

In one embodiment of the present disclosure, the coil film and the magnet are disposed at the corner of the L-shaped chamber.

### DESCRIPTION OF DRAWINGS

FIG. 1 is a schematic diagram of an actuator according to a first embodiment of the present disclosure.

FIG. 2 is a schematic diagram of a magnetic field B produced by the interaction between a coil film and a magnet of an actuator of the present disclosure.

FIG. 3 is a schematic side view of a coil film and a magnet of an actuator of the present disclosure.

FIG. 4 is a schematic diagram of connected coils in a coil film of an actuator of the present disclosure.

FIG. 5 is a schematic diagram of an actuator during an intake mode according to the first embodiment of the present disclosure.

FIG. 6 is a schematic diagram of an actuator during an exhaust mode according to the first embodiment of the present disclosure.

FIG. 7 is a schematic diagram of an actuator according to a second embodiment of the present disclosure.

FIG. 8 is a schematic diagram of an actuator according to a third embodiment of the present disclosure.

### DETAILED DESCRIPTION OF PREFERRED EMBODIMENTS

In order to make the above and other objectives, features, and advantages of the present disclosure more obvious and understandable, the following exemplifies the preferred embodiments of the present disclosure, combined with the accompanying drawings, and describe in detail as follows.

The figures in the subject application are all schematic. Specifically, the proportions, sizes, or appearances of the components in the figures are schematic representations and do not reflect the actual proportions, sizes, or appearances of the components. For example, the thickness, length, and proportions of the magnets and substrates in the present disclosure are not exhibited based on the actual physical dimensions of the real products. Additionally, for the sake of simplicity, multiple flat coils mentioned below may be represented as a single flat coil in the figures in some cases. Similarly, circuit boards composed of multiple layers of substrates mentioned below may be also represented as a single substrate in the figures in some cases. Furthermore, upper and lower or left and right described in the present disclosure refer to relative positions and directions. For example, from one perspective, a magnet may be positioned above a flat coil, while from another perspective, the magnet may be positioned below the flat coil.

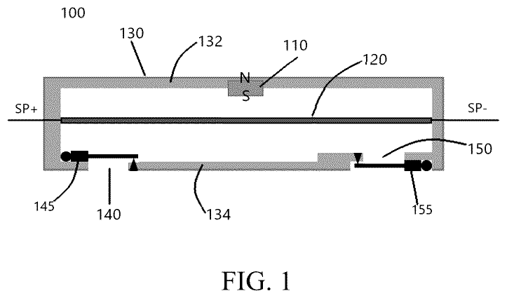

Firstly, please refer to FIG. 1. FIG. 1 is a schematic diagram of an actuator according to a first embodiment of the present disclosure. The actuator 100 in the first embodiment of the present disclosure primarily includes a first magnet 110, a coil film 120, and a chamber 130. In various embodiments, the chamber 130 may be a rectangular chamber, a square chamber, or a symmetric or asymmetric chamber, etc., and is not limited thereto. The sides of the chamber 130 may be straight or curved, and are not limited thereto. For ease of explanation and understanding, the chamber 130 of the actuator 100 in the first embodiment of the present disclosure is predetermined as a rectangular chamber. In this embodiment, preferably, the first magnet 110 is a thin, strong magnet or a strong magnetic sheet. In one embodiment, the coil film 120 may consist of a single flat coil and a single substrate, which are small in size and lightweight. Preferably, the coil film 120 is composed of multiple flat coils and multiple substrates. The “multiple substrates” refers to a multilayer substrate (i.e., a plurality of substrates stacked) and may include flexible substrates, such as a flexible printed circuit (FPC), and is not limited thereto. The coil film 120 is placed in the central area of the chamber 130. The chamber 130 includes two long side frames (a first side frame 132 and a second side frame 134, respectively) and two short side frames. The first magnet 110 is positioned on the common central axis of the multiple flat coils of the coil film 120 and is located between the coil film 120 and the first side frame 132. Specifically, the first magnet 110 may be attached to the wall surface of the first side frame 132 or embedded within the first side frame 132.

The chamber 130 is not a closed chamber, and has an inlet 140 and an outlet 150. The inlet 140 and outlet 150 are arranged on the other side opposite to the first side frame 132, namely on the side of the second side frame 134. An inlet gate 145 is provided at the inlet 140, and an outlet gate 155 is provided at the outlet 150.

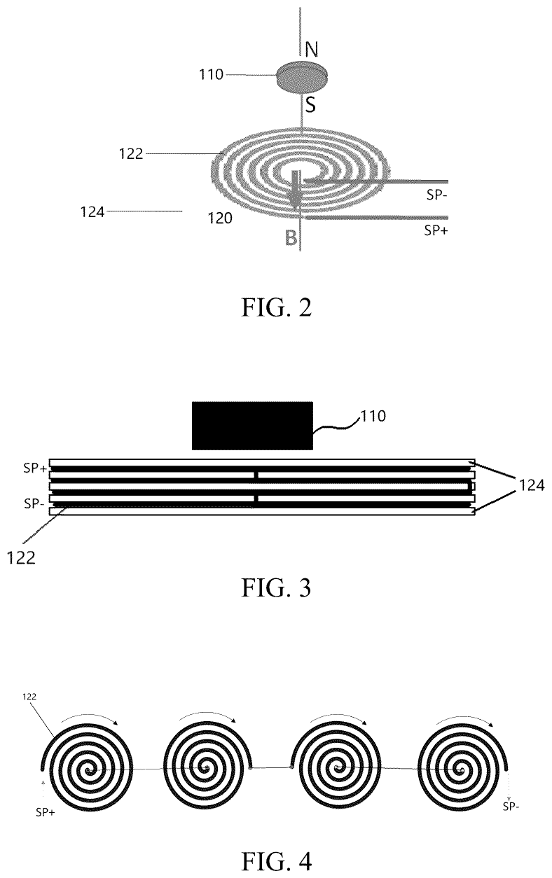

Please refer to both FIG. 2 and FIG. 3. FIG. 2 is a schematic diagram of a magnetic field B produced by the interaction between a coil film and a magnet of an actuator of the present disclosure. FIG. 3 is a schematic side view of a coil film and a magnet of an actuator of the present disclosure. As previously mentioned, the coil film 120 can be composed of a single flat coil 122 and a single substrate 124, or multiple flat coils 122 and multiple substrates 124. In the case of a single flat coil 122 (as shown in FIG. 2), the flat coil 122 is formed on the substrate 124. The first magnet 110 is positioned along the central axis of the flat coil 122, either on the upper or lower side of the coil film 120. In the case of multiple flat coils 122 (as shown in FIG. 3), the flat coils 122 are interconnected and stacked, with each flat coil 122 being formed on the multilayer substrate 124. It should be noted that these flat coils 122 are stacked based on a common central axis, meaning that the central axes of each flat coil 122 overlap with one another. The first magnet 110 is positioned along the common central axis of the multiple flat coils 122, either on the upper or lower side of the coil film 120.

When a flat coil is energized, a magnetic field B generated is concentrated at the center point, meaning that the magnetic field strength in the central area of the flat coil is much greater than in other areas. Therefore, in one embodiment, when a magnet is placed at the center of the flat coil and the signal terminal (SP+ and SP−) of the signal amplifier outputs a current, the flat coil and the magnet interact (either repelling or attracting each other), causing the substrate to vibrate and generate shockwaves. In this embodiment, the first magnet 110 and the coil film 120 do not have to be in contact with each other. As long as they are close enough, they will interact when the flat coil 122 is energized.

Please refer to FIG. 4. FIG. 4 is a schematic diagram of connected coils in a coil film of an actuator of the present disclosure. In some embodiments, the coil film 120 may include one flat coil, two flat coils, or more flat coils. In a preferred embodiment, taking four flat coils as an example, from left to right, they are the first coil to the fourth coil, and the four flat coils 122 are interconnected. The outer terminal of the first coil is connected to the signal terminal SP+ of the signal amplifier, the center terminal of the first coil is connected to the center terminal of the second coil, the outer terminal of the second coil is connected to the outer terminal of the third coil, the center terminal of the third coil is connected to the center terminal of the fourth coil, and the outer terminal of the fourth coil is connected to the signal terminal SP− of the signal amplifier. Each flat coil 122 is stacked and formed on its respective corresponding substrate 124, as shown in FIG. 3. In FIG. 4, the arrows represent the direction of the current. The interaction between the first magnet 110 and the coil film 120 in the actuator 100 generates vibrational forces, producing shockwaves. The connected multiple flat coils 122 form a high-turn coil, and since the current flows in the same direction, magnetic fields in the same direction are generated, outputting stronger power, leading to more intense diaphragm vibrations, and finally forming stronger shockwaves.

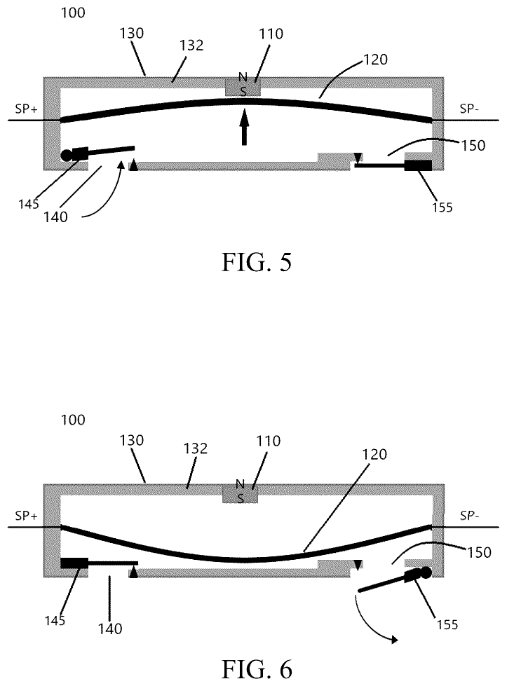

Please refer to FIG. 5 and FIG. 6. FIG. 5 is a schematic diagram of an actuator during an intake mode according to the first embodiment of the present disclosure. FIG. 6 is a schematic diagram of the actuator during an exhaust mode according to the first embodiment of the present disclosure. When the actuator 100 is powered on, a repulsive or attractive interaction occurs between the first magnet 110 and the coil film 120, depending on the direction and strength of the current. Specifically, when the actuator 100 is powered to operate in an intake mode, the first magnet 110 and the coil film 120 attract each other. Since both ends of the coil film 120 are fixed and the first magnet 110 is fully secured to the first side frame 132, along with the magnetic field produced by the coil film 120 being concentrated in the central area, part of the coil film 120 moves closer to that side of the first magnet 110 and the first side frame 132. In particular, the central part of the coil film 120 moves closer to the first magnet 110. This mutual attraction causes the coil film 120 to deform, bending into an arc shape, as shown in FIG. 5. Conversely, when the actuator 100 is powered to operate in an exhaust mode, the first magnet 110 and the coil film 120 repel each other. Since both ends of the coil film 120 are fixed and the first magnet 110 is fully secured to the first side frame 132, along with the magnetic field produced by the coil film 120 being concentrated in the central area, part of the coil film 120 moves close to that side of the second side frame 134 (the coil film 120 is pushed away from the first magnet 110). In particular, the central part of the coil film 120 moves farther from the first magnet 110. This mutual repulsion similarly causes the coil film 120 to deform, bending into an arc shape in the direction of the second side frame 134, as shown in FIG. 6.

When the actuator 100 operates in the intake mode, the inlet gate 145 is configured for forward operation, while the outlet gate 155 is configured for reverse operation. Therefore, the inlet gate 145 opens, allowing airflow to be drawn into the chamber 130 from the inlet 140, while the outlet gate 155 closes, preventing airflow from entering or leaving the chamber 130 through the outlet 150, as shown in FIG. 5. When the actuator 100 operates in the exhaust mode, the inlet gate 145 is configured for reverse operation, and the outlet gate 155 is configured for forward operation. Thus, the inlet gate 145 closes, preventing airflow from entering or leaving the chamber 130 through the inlet 140, while the outlet gate 155 opens, allowing airflow to be expelled from the chamber 130 through the outlet 150, as shown in FIG. 6. This design ensures that the actuator 100 can effectively control the inflow and outflow of air in different states, achieving the desired effect through precise control of the interaction between the first magnet 110 and the coil film 220.

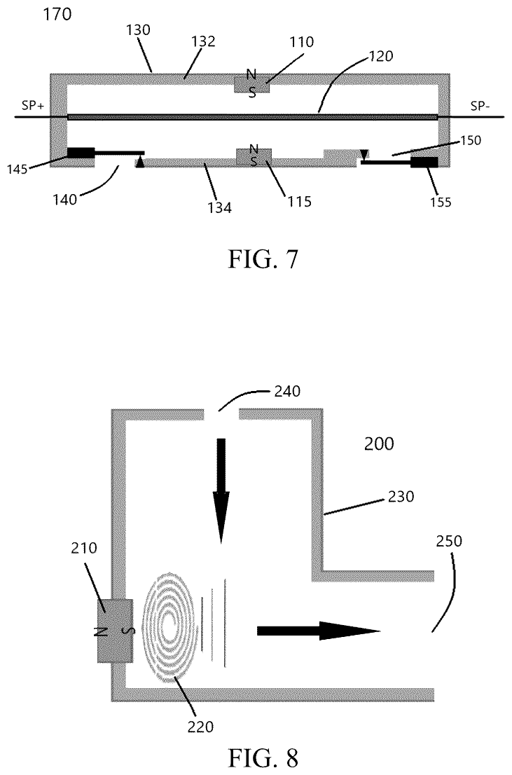

Please refer to FIG. 7. FIG. 7 is a schematic diagram of an actuator according to a second embodiment of the present disclosure. In this embodiment, the actuator 170 further includes a second magnet 115. The second magnet 115 is similar to the first magnet 110 and can be a thin, powerful magnet or a strong magnetic sheet, interacting with the coil film 120 as well. The second magnet 115 is positioned on the common central axis of the multiple flat coils of the coil film 120 and located between the coil film 120 and the second side frame 134 of the chamber 130. Similarly, the second magnet 115 can be attached to the second side frame 134 or embedded within the second side frame 134. With the presence of the second magnet 115, the coil film 120 interacts with both magnets simultaneously, generating stronger vibrational effects.

The following explanation maps the operational scenarios of the actuator 170 in FIG. 7 to the those in FIGS. 5 and 6. When the actuator 170 is in the intake mode, the first magnet 110 attracts the coil film 120, while the second magnet 115 repels the coil film 120, causing the coil film 120 to deform and bend into an arc shape, with part of the coil film 120 moving closer to that side of the first magnet 110 and the first side frame 132. Since the inlet gate 145 is configured for forward operation in the intake mode, it opens, allowing airflow to enter the chamber 130 from the inlet 140. Since the outlet gate 155 is configured for reverse operation in the intake mode, it closes, preventing airflow from entering or leaving the chamber 130 through the outlet 150. When the actuator 170 switches to the exhaust mode, the first magnet 110 repels the coil film 120, while the second magnet 115 attracts the coil film, causing the coil film 120 to deform and bend into an arc shape, with part of the coil film 120 moving closer to that side of the second magnet 115 and the second side frame 134. Since the outlet gate 155 is configured for forward operation during exhaust, it opens, allowing airflow to be expelled from the chamber 130. Since the inlet gate 145 is configured for reverse operation during exhaust, it closes, preventing airflow from entering or leaving the chamber 130 through the inlet 140. This design enables the coil film 120 of the actuator 170 to interact with both magnets simultaneously, generating stronger shockwave effects. These stronger shockwave effects enhance the suction and thrust of the actuator 170, allowing it to control airflow more efficiently across various operational states.

Next, please refer to FIG. 8. FIG. 8 is a schematic diagram of an actuator according to a third embodiment of the present disclosure. The actuator 200 of the third embodiment includes a magnet 210, a coil film 220, and an L-shaped chamber 230. The characteristics and operating principles of the magnet 210 and the coil film 220 in the actuator 200 are similar to those of the first magnet 110 and the coil film 120 in the actuator 100 (refer to the explanations for FIGS. 2 to 4), so they will not be repeated here.

The L-shaped chamber 230 is provided with an inlet 240 and an outlet 250. The inlet 240 is located at the head end of the L-shaped chamber 230, while the outlet 250 is at the tail end. The coil film 220 and the magnet 210 are positioned at the corner of the L-shaped chamber 230. The magnet 210 is disposed on the common central axis of the multiple flat coils of the coil film 220 and located between the coil film 220 and the side wall of the L-shaped chamber 230. This configuration causes the force generated by the interaction between the coil film 220 and the magnet 210 to be directed toward the outlet 250. In one application of this embodiment, when water or air flows into the inlet 240, the shockwaves produced by the interaction between the coil film 220 and the magnet 210 will propel the water or air toward the outlet 250. In other embodiments, gates (not shown) can also be installed at the inlet 240 and outlet 250 of the L-shaped chamber 230.

The actuator of the present disclosure generates shockwaves by the combination of a flat coil, a flexible substrate and a small, powerful magnet to achieve diaphragm vibrations. This structural design is simple and efficient. For example, in terms of heat dissipation, the actuator can facilitate airflow by generating shockwaves, thereby enhancing cooling efficiency; in terms of fluid propulsion, the actuator's vibrations can effectively propel liquids or gases, making it suitable for microfluidic systems; in term of air circulation, the actuator can enhance ventilation and improve indoor air quality. Compared to existing technologies, the actuator of the present disclosure has several significant advantages. First, its simple structural design allows for a more efficient manufacturing process, reducing production time and costs. Second, due to the use of small, powerful magnets and flexible substrates, the actuator is made compact and lightweight, making it easy to integrate into various devices. Furthermore, the manufacturing process of this actuator is relatively straightforward, which not only increases production efficiency but also lowers production costs, giving it a competitive advantage in pricing.

The above is only exemplary, rather than restrictive. Any equivalent modifications or changes without departing from the spirit and scope of the present disclosure should fall within the scope of the appended claims.

What is claimed is:

1. An actuator, comprising:
a chamber, having an inlet and an outlet;
a coil film, disposed in the chamber and including a plurality of flat coils and a plurality of stacked substrates, wherein the plurality of flat coils are interconnected and respectively formed on the substrates; and
a first magnet, disposed on a common central axis of the plurality of flat coils and located between the coil film and a first side frame of the chamber.

2. The actuator according to claim 1, wherein the film is a flexible circuit board.

3. The actuator according to claim 1, wherein the inlet and the outlet are provided on the other side opposite to the first side frame.

4. The actuator according to claim 1, wherein the inlet is provided with an inlet gate and the outlet is provided with an outlet gate.

5. The actuator according to claim 4, wherein the inlet gate and the outlet gate operate with inverse actions.

6. The actuator according to claim 1, further comprising a second magnet, the second magnet is disposed on a common central axis of the plurality of flat coils and is located between the coil film and a second side frame of the chamber.

7. An actuator, comprising:
an L-shaped chamber, having an inlet and an outlet;
a coil film, disposed in the L-shaped chamber and including a plurality of flat coils and a plurality of stacked substrates, wherein the plurality of flat coils are interconnected and respectively formed on the substrates; and
a magnet, disposed on a common central axis of the plurality of flat coils and located between the coil film and one side wall of the L-shaped chamber;
wherein a force produced by the interaction between the coil film and the magnet is directed toward the outlet.

8. The actuator according to claim 7, wherein the film is a flexible circuit board.

9. The actuator according to claim 7, wherein the inlet is located at the head end of the L-shaped chamber and the outlet is located at the tail end of the L-shaped chamber.

10. The actuator according to claim 7, wherein the coil film and the magnet are disposed at the corner of the L-shaped chamber.
